(19) United States
(12) Patent Application Publication
(10) Pub. No.: US 2019/0135426 A1
(43) Pub. Date: May 9, 2019

(54) SHORT TAKE OFF AND LANDING AERIAL VEHICLE

(71) Applicant: William Bailie, White Rock (CA)

(72) Inventor: William Bailie, White Rock (CA)

(21) Appl. No.: 16/308,412

(22) PCT Filed: Jun. 29, 2017
(86) PCT No.: PCT/CA2017/050793

§ 371 Date: Dec. 7, 2018

(30) Foreign Application Priority Data
Jun. 29, 2016 (CA) 2934346

(51) Int. Cl. B64C 29/00; B64D 5/00; B64C 3/56; B64C 39/12; B64C 27/28

(52) U.S. Cl. CPC B64C 29/0033; B64D 5/00; B64C 2201/206; B64C 39/12; B64C 27/28; B64C 3/56

(57) ABSTRACT

An aircraft includes a fuselage having an outer surface profile selected to conform to an airfoil profile and at least one engine located within the fuselage. The aircraft further includes a plurality of air intakes distributed over a top surface of the outer surface and at least one duct extending through the fuselage wherein the at least one duct is in fluidic communication with the plurality of air intakes and the at least one engine.

### BACKGROUND OF THE INVENTION

### 1. Field of Invention

The present invention relates generally to aircraft and in particular to a cruise efficient conventional vertical short take-off and landing aircraft.

### 2. Description of Related Art

Aircraft are commonly required to carry cargo and passengers between destinations which are considered too far or impractical for other forms of transportation. Difficulties with conventional aircraft are the size of the aircraft relative to the volume or weight of cargo and passengers it can carry. In particular conventional aircraft include a fuselage with at least two wings extending therefrom. In such configurations, the wings provide the only significant lift for the aircraft and the fuselage contains the cargo to be transported.

One disadvantage of such systems is that the cargo volume is limited by the size of the fuselage and the weight of the cargo is limited by the size of the wings. As each of the fuselage and wings provide different functions, each will be a limitation on the cargo that the aircraft can carry.

Additionally, many conventional aircraft rely almost exclusively on propulsion to create forward velocity and therefore lift from the wings. This therefore limits the lower speed at which the aircraft can fly to achieve proper lift and also limits the length of the runway that must be required for such aircraft.

Helicopters are a style of aircraft capable of vertical take-off, thereby limiting the length of runways required for such aircraft. However, disadvantageously, helicopters are limited to the speeds they may achieve due to the speed difference between the advancing blade and retreating blades.

### SUMMARY OF THE INVENTION

According to a first embodiment of the present invention there is disclosed a cruise efficient conventional vertical short take-off and landing aircraft comprising a fuselage having an outer surface profile selected to conform to an airfoil profile and at least one engine located within the fuselage. The aircraft further comprises a plurality of air intakes distributed over a top surface of the outer surface and at least one duct extending through the fuselage wherein the at least one duct is in fluidic communication with the plurality of air intakes and the at least one engine.

The aircraft may further comprise a plurality of raised ridges extending upwards from the fuselage along the top surface thereof between a location proximate to a front of the fuselage and a rear of the fuselage. The aircraft may further comprise a plurality of airflow removal ports extending through the fuselage proximate to the plurality of raised ridges in fluidic communication with the at least one duct. Each of the plurality of raised ridges may comprise a group consisting of a center ridge extending along a centerline of the fuselage, an outer ridge extending proximate to a side edge of the fuselage and an intermediate ridge located between the center ridge and the outer ridge.

The center ridge may include convex lateral surfaces. The intermediate ridge may include concave inward and outward facing lateral surfaces. The outer ridge may include a concave inward facing lateral surface.

The plurality of air intakes may be distributed lengthwise over the top surface of the fuselage. The plurality of air intakes may be distributed along the top surface at each of three locations along a length of the fuselage. The plurality of air intakes may have a profiled NACA duct configuration. A rearmost of the plurality of air intakes may include scoops extending thereabove from the top surface of the fuselage. The scoops may include pressure relief panels extending therethrough operable to open upon over pressurization of air under the scoops.

The aircraft may further comprise a plurality of air outlet nozzles along a bottom surface of the fuselage to express air therefrom. The plurality of air outlet nozzles may be distributed transversely across the bottom surface of the fuselage. The plurality of air outlet nozzles may be distributed along the bottom surface at each of three locations along a length of the fuselage. The plurality of air outlet nozzles may be oriented in a direction towards the rear of the fuselage so as to express air therefrom along the fuselage. Each of the plurality of air outlet nozzles may include a valve therein. Each of the plurality of air outlet nozzles may include a dimple in the fuselage located downstream therefrom.

The aircraft may further comprise at least one air expression slots extending transversely across the fuselage adapted to express air therefrom located along at least one of the bottom or top of the fuselage. The at least one air expression slots may be oriented in a direction towards the rear of the fuselage so as to express air therefrom along the fuselage. At least one of the air expression slots may include a depression located rearwardly of the at least one of the air expression slots. At least one of the air expression slots may include an airfoil adapted to be moved between a retracted position within the fuselage and an extended position substantially parallel to and apart from the fuselage at a position proximate to and rearward of the air expression slot. The airfoil may include air expression outlets on top and bottom surfaces thereof adapted to express air therefrom in a direction generally towards a rear of the fuselage.

The aircraft may further comprise a plurality of longitudinal troughs located into the fuselage along at least one of the top or bottom of the fuselage. The troughs may include an air bladder therein so as to be operable to fill the trough to conform to the adjacent profile of the fuselage.

The aircraft may further comprise a plurality of fans selectably retractable into the fuselage. The at least one fan may comprise a ducted fan. At least one of the plurality of fans may be rotatable about an axis which is orientable in a direction to be varied between vertical to provide vertical lift to the aircraft and horizontal to provide thrust to the aircraft and combinations thereof.

The aircraft may include at least one duct extending vertically through the fuselage. The at least one duct may include a fan therein. The at least one duct may be selectably openable and closable to isolate the fan within the duct.

The aircraft may include at least one duct extending through a wing extending therefrom. The at least one duct may include a fan therein. At least one of the plurality of fans may be rotatable about an axis which may be oriented in a direction which may be varied between vertical to provide lift to the aircraft and horizontal to provide thrust to the aircraft and combinations thereof. The at least one of plurality of fans is positioned to blow air across the top surface of the fuselage.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a top plan view of an aircraft according to a first embodiment of the present invention.

FIG. 1A is a detailed cross-sectional view of the fan shrouds of the aircraft of FIG. 1 as taken along the line A-A in FIG. 1.

FIG. 1B is a detailed cross-sectional view of one of the airflow orientation troughs of the aircraft of FIG. 1 as taken along the line B-B in FIG. 1.

FIG. 1C is a detailed cross-sectional view of one of the airflow orientation troughs of the aircraft of FIG. 1 in the inflated or filled position.

FIG. 2 is a top plan partial cut away illustration of the aircraft of FIG. 1.

FIG. 2A is a detailed cross-sectional side view of a portion of the aircraft of FIG. 1.

FIG. 2B is a detailed cross-sectional view of a laminar flow enhancement device of the aircraft of FIG. 1 utilized in the airflow enhancement compressed air expression slots of FIG. 9F.

FIG. 3 is a bottom plan view of the aircraft of FIG. 1.

FIG. 3A is a detailed view of the front ducted fan of the aircraft of FIG. 1 in an open position.

FIG. 3B is a detailed cross-sectional view of one of the airflow enhancing nozzles as taken along the line B-B in FIG. 3.

FIG. 4 is a front view of the aircraft of FIG. 1.

FIG. 4A is a detailed view of outer airflow alignment strakes of the aircraft of FIG. 1 as taken from FIG. 4.

FIG. 4B is a detailed view of central airflow alignment strakes of the aircraft of FIG. 1 as taken from FIG. 4.

FIG. 4C is a detailed view of intermediate airflow alignment strakes of the aircraft of FIG. 1 as taken from FIG. 4.

FIG. 5 is a front view of the aircraft of FIG. 1 with the fans retracted.

FIG. 6 is a rear view of the aircraft of FIG. 1.

FIG. 7 is a right-side view of the aircraft of FIG. 1.

FIG. 8 is a right-side view of the aircraft of FIG. 1 at a further configuration.

FIG. 8A is a front view of the aircraft of FIG. 1 in the configuration of FIG. 8.

FIG. 9 side view of the aircraft of FIG. 1 with all fans and propellers retracted.

FIG. 9A is a detailed cross-sectional view of the air intake for the engines of the aircraft of FIG. 1 at the location referenced in FIG. 9 as 9A.

FIG. 9B is a detailed cross-sectional view of an air intake of the aircraft of FIG. 1 at the location referenced in FIG. 9 as 9B at a further position therealong.

FIG. 9C is a detailed cross-sectional view of an air intake of the aircraft of FIG. 1 at the location referenced in FIG. 9 as 9C at a further position therealong.

FIG. 9D is a detailed cross-sectional view of an air expression airflow enhancement device on the top surface of the aircraft of FIG. 1 at the location referenced in FIG. 9 as 9D at a further position therealong.

FIG. 9E is a detailed cross-sectional view of an air expression airflow enhancement device along the bottom of the aircraft of FIG. 1 at the location referenced in FIG. 9 as 9E.

FIG. 9F is a detailed cross-sectional view of an air expression slot and rotatable and retractable airflow enhancement device along the top of the aircraft of FIG. 1 at the location referenced in FIG. 9 as 9F.

FIG. 10 is a front view of the aircraft of FIG. 1 at a further configuration.

### DETAILED DESCRIPTION

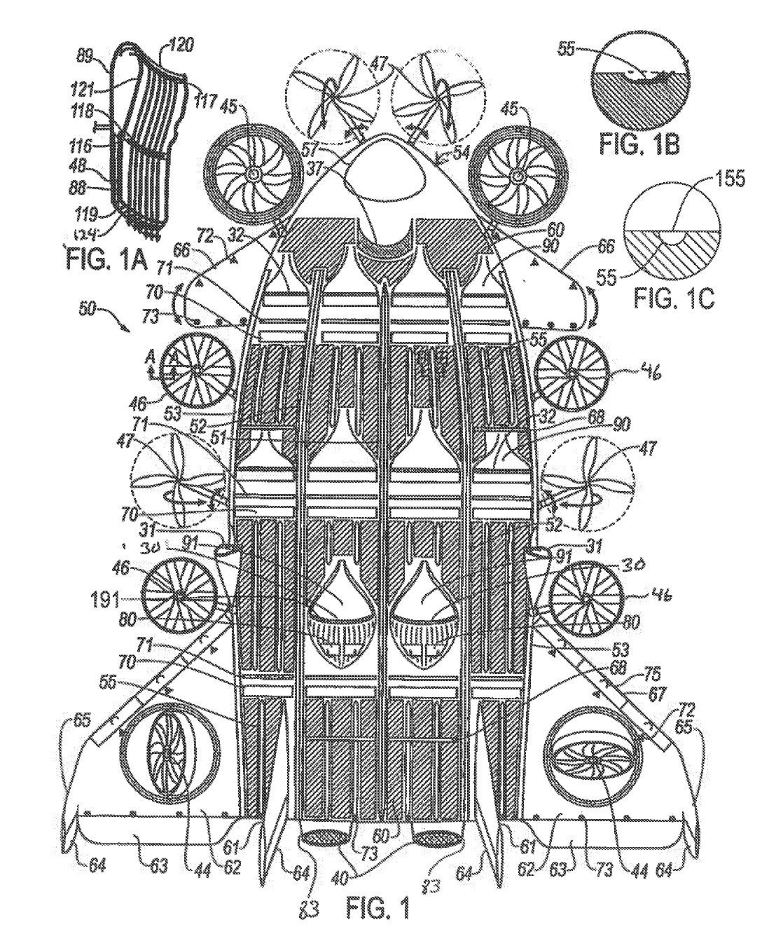

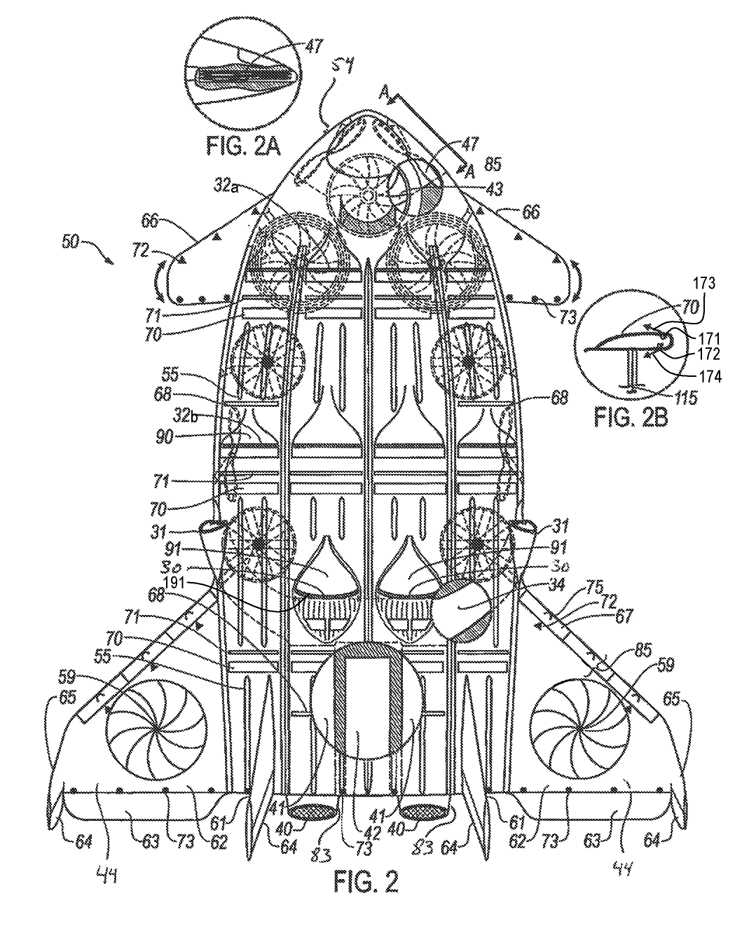

Referring to FIG. 1, an aircraft according to a first embodiment of the invention is shown generally at 50. The aircraft 50 is designed primarily as a Cruise Efficient Vertical or Short Take-Off and Landing vehicle. The body, or fuselage 54 of the aircraft, is an airfoil shape. As such, the entire fuselage is a lifting device. It will be appreciated that any desired airfoil shape may be selected for the fuselage according to the design requirements of the aircraft. Around the perimeter of the fuselage 54, various propellers and fans are shown in a variety of their extended orientations. Located at the nose of the aircraft, and at the sides of the fuselage in the mid chord area, the retractable pivotal realign-able counter rotating stacked propeller pairs 47 are shown. As illustrated in FIG. 2A, the Retractable Pivotal Realign-able Counter rotating Stacked Propeller Pair 47 may be stowed within the fuselage.

On either side of the nose of the aircraft are shown the forward retractable contractible gimballed ducted fans 45. On either side of the mid portion of the Aircraft are the retractable rotatable contractible side ducted fans 46. It will be appreciated that although a plurality of ducted fans and open propellers are illustrated at different locations along the aircraft, such fans, ducted fans and propellers may be substituted for each other in each location and some may be optionally omitted. It will also be appreciated that such fans, ducted fans and propellers may be fixed or rotatably mounted to the aircraft with gimbals as will be further described below and illustrated.

The upper surface and a significant portion of the sides of the Wing/Fuselage 54 are covered with Solar Collector Panels 60, allowing many of the components of the aircraft to be powered electrically from that source. This embodiment increases the range of the aircraft and provides a back-up power source for components, in the event of reduced capacity of the other power generating systems in the aircraft.

As illustrated in FIG. 2, the propellers and fans may be retracted within the wing/fuselage 54, and shown as “hashed” lines. Additionally, the front central fan 43 is shown, partially as “hashed” lines and partially as a cutaway view. Also shown on the right aft portion of the wing/fuselage 54, as a cutaway, is the Engine and APU air intake Plenum 34. Further shown in a separate cutaway at the aft area of the wing/fuselage are two engines 41 and the Auxiliary Power Unit (APU) 42. On the reactive control wings, the aft retractable contractible gimballed ducted Fans 44, (not shown) are covered with drag reducing Iris Vane Covers 59. The engines 41 may be of a conventional type such as, by way of non-limiting example, turbofan engines wherein all or part of the airflow outputted from the fan may be captured and redirected through internal piping to power each of the fans, propellers and airflow enhancement devices of the aircraft as described below. It will also be appreciated that the fans, propellers and other airflow enhancement devices may be powered by any other means as are commonly known, such as, by way of non-limiting example, mechanical, electrical, pneumatic, or hydraulic.

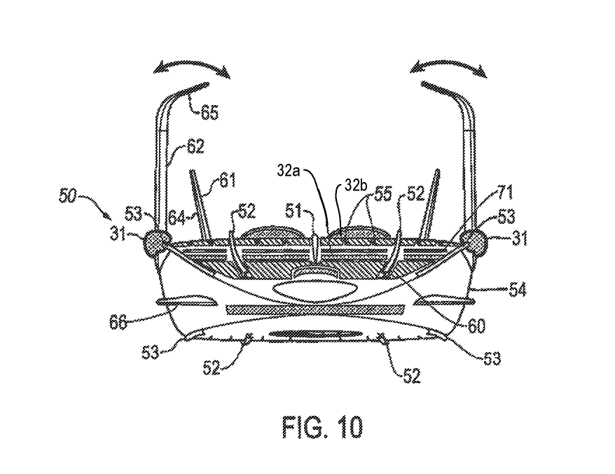

To enhance the stability and maneuverability of the aircraft, adjustable Canards 66 are fixed to the forward part of the wing/fuselage, and Reactive Control Wings 62 are attached to the rear portion of the aircraft which may be raised to the vertical position for compact storage as illustrated in FIG. 10. Combined Roll Control/Elevator/Trim tabs 63 are attached to the back of the reactive wings. Combined Vertical Stabilizer 61/Roll Assist and Rudder Devices 64 are mounted at the rear of the aircraft, along with Rudders 64 attached to the Winglets 65.

The aircraft 50 includes a plurality of air inlets distributed lengthwise along the upper surface to feed air into a common upper fuselage engine air intake plenum 33, as will be described in more detail below. As illustrated, the air inlets are distributed at three locations along the length of the fuselage 54, as will be described in more detail below, although it will be appreciated that the air inlets may be distributed in more or less locations. The purpose of the air inlets is to increase wing efficiency while feeding and cooling the engines 41. In particular, the use of multiple air inlets at multiple locations along the top surface will draw air from the top surface of the fuselage so as to draw down the boundary layer thereby improving boundary layer attachment and entrainment as well as additional air flow along the full length of the long chord of the airfoil of the fuselage. It will be appreciated that such improved boundary layer airflow will also thereby improve the efficiency and lift of the fuselage.

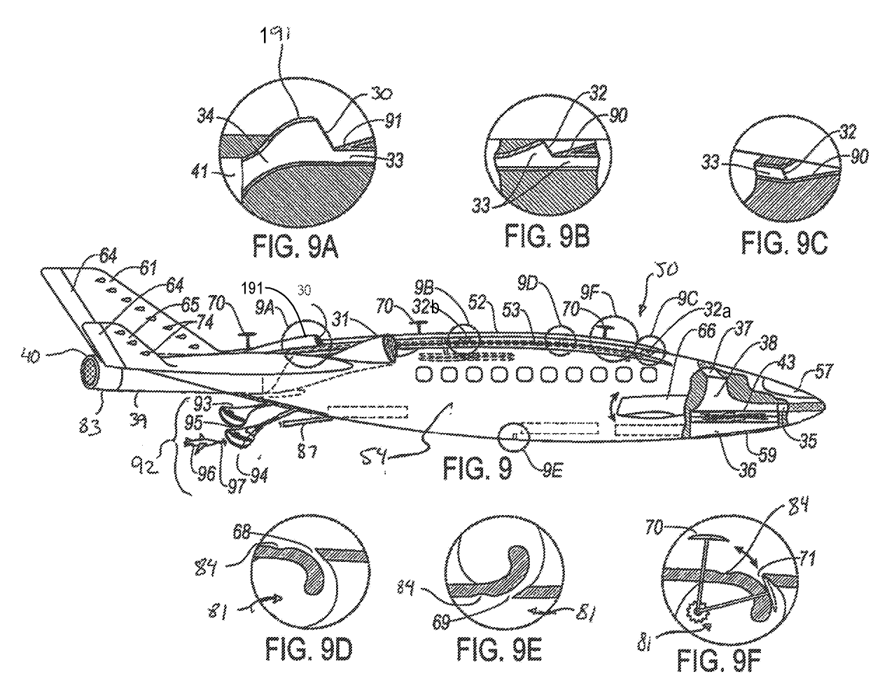

By way of non-limiting example, the plurality of air inlets may be distributed as described and illustrated herein. In particular, as illustrated in FIG. 1, the main engine air inlets 30 are located forward of the vertical stabilizers and may include a recessed NACA profile engine air inlet vent 91 or any other commonly known inlet shape with a projecting scoop 191 extending thereabove, as best illustrated in FIG. 9A. The projecting scoop 191 extends above the top surface of the fuselage to draw air into the main engine air inlets. As further illustrated, pressure relief vanes 80 may be located through the scoops 191. The pressure relief vanes 80 comprise movable plates through the scoops 191 which are adapted to be openable so as to reduce the airflow captured by the scoops 191 thereby preventing over pressurization of the contoured NACA engine air inlet vent 91. It will be appreciated that the vanes may be opened in response to an increased air pressure within the contoured NACA engine air inlet vent 91 such as through the use of a spring or other force specific actuator. The scoop 191 are adapted to capture a greater volume of air into the contoured NACA engine air inlet vent 91 at lower speeds of the aircraft. Outboard of the main engine air inlets are the side engine air intake shrouds 31 also in fluidic communication with the engines to supply air thereto as are commonly known. Further forward at the mid-chord area and still further forward at the area between the canard segments, are shown the middle and front upper fuselage engine air intakes, 32b and 32a, respectively. Each of the middle and front upper fuselage engine air intakes 32b and 32a may include a recessed NACA engine air inlet vent 90 as is commonly known or any other suitable configuration. It will be appreciated that each of the main engine air inlets 30 and middle and front upper fuselage engine air intakes are will be sized to provide, in combination, an amount of air required by the engines. Furthermore, the main engine air inlets 30 and middle and front upper fuselage engine air intakes will be sized relative to each other such that the volume of air removed by each of them will be selected to maintain boundary layer attachment according to known principles.

Just aft of both rows of upper fuselage engine air intakes 32, and also aft of the main engine air intakes 30, are shown combined tomahawk retraction and airflow enhancement compressed air expression slots 71. Further aft of those slots are shown the tomahawk retractable laminar flow enhancement devices 70, in the extended orientation. As further depicted in FIG. 2B, of the tomahawk retractable laminar flow enhancement device 70 comprises an airfoil shape adapted to be oriented substantially parallel to the surface of the fuselage. The tomahawk retractable laminar flow enhancement device 70 includes a compressed air supply 115, and upper and lower compressed air expression slots 171 and 172, respectively extending along the top and bottom surface thereof. The upper and lower compressed air expression slots 171 and 172 are oriented to express air in a substantially rearward direction as indicated by arrows 173 and 174. It will be appreciated that the shape if the tomahawk retractable laminar flow enhancement device 70 as well as the upper and lower air expression slots 171 and 172 are adapted to induce airflow along the fuselage and entrain such airflow within the boundary layer around the fuselage. Near the forward part of the upper fuselage/wing 54, are located the front central fan upper air intake 37, and the central operational control area 57.

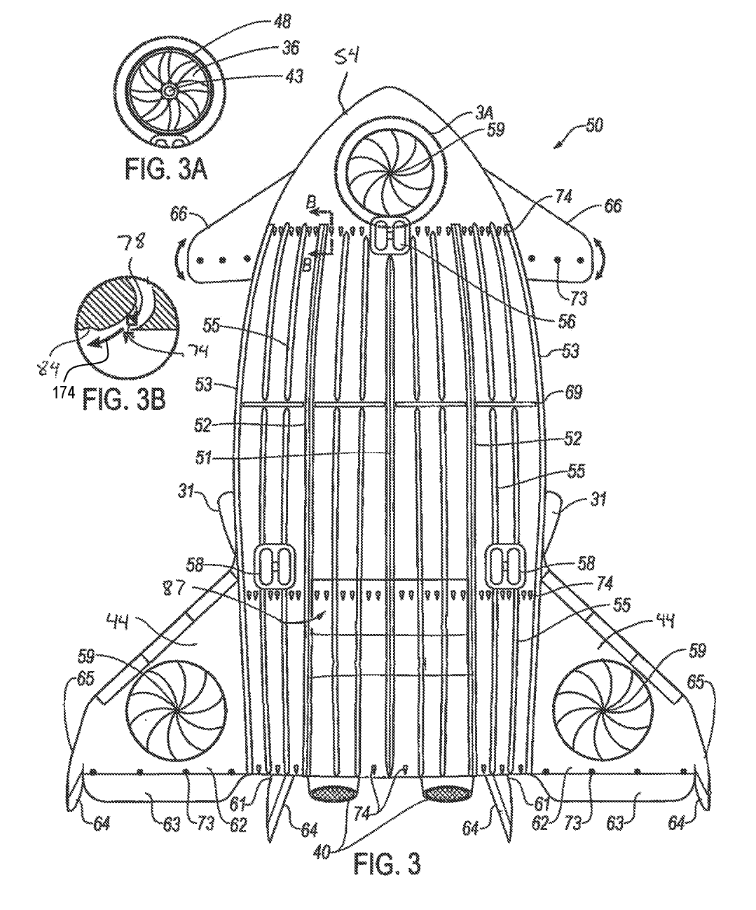

Turning now to FIG. 3, the underside of the Aircraft 50 includes the Iris Vane Ducted Fan Cover 59 on the Front Central Fan 43 (shown in FIG. 3A) and on the Aft Ducted Fans 44 (not shown). Also shown are the Stream Airflow Enhancement Nozzles 74 near the Nose Landing Gear 56 and near the Main landing Gear 58, as well as near the trailing edge of the wing/fuselage 54 although it will be appreciated that stream airflow enhancement nozzles 74 may be utilized at other locations and in more or less sets as well. Air is ejected through the stream airflow enhancement nozzles 74 from an air supply system, which may include the engine 41 or any other air supply source, towards the rear of the aircraft 50, in a direction generally indicated at 174 in FIG. 3B. Sheet Airflow Enhancement Nozzles 73 are located near the trailing edges of the Canard segments 66. Proximate to the mid-chord area of the fuselage, the Lower Fuselage Airflow Enhancement Compressed Air Expression Slots 69 are shown. On the trailing edges of the Reactive Control Wings, are found the Sheet Airflow Enhancement Nozzles 73 and Combination Roll Control/Elevators/Trim Tabs 63. The Engine Thrust Vectoring Nozzles 40 protrude from the back of the Wing/Fuselage 54 and also shown are the thrust vectoring nozzle cooling and airflow enhancement duct 83 as illustrated in FIG. 2. The Winglets 65 and the Rudders 64 are found at the outer sides of the Reactive Control Wings 62. The Lower Surface Airflow Orientation Troughs 55, the center 51, Intermediate 52, and Outer 53 Fuselage Airflow Alignment Strakes run from the front to the aft of the Wing/Fuselage 54. Also shown are the Side Engine Air intake Shrouds 31 and the Aft Hatch 87. The Stream Airflow Enhancement Nozzles 74 may also include an airflow adhesion enhancement profile 84 comprising a dimple located downstream thereof adapted to retain the airflow exiting the nozzles 74 and flowing therepast close to the fuselage and maintain the boundary layer attachment. Similar airflow enhancement profiles may also be provided downstream of the air expression slots illustrated in FIGS. 9D-9F.

As illustrated in FIG. 3A, the Front Central Fan 43, reference located by the annotation 3A near the nose of FIG. 3, is covered by the closed Iris Vanes 59, as shown in FIG. 3. Also shown in FIG. 3A are the Ducted Fan Shroud 48 and the Front Central Fan Discharge 36. As illustrated in FIG. 3B, a detailed view of the Stream Airflow Enhancement Nozzles 74 is shown, including a symbol indicating a modulating valve 78, reference located as B - - - B on the forward area of FIG. 3

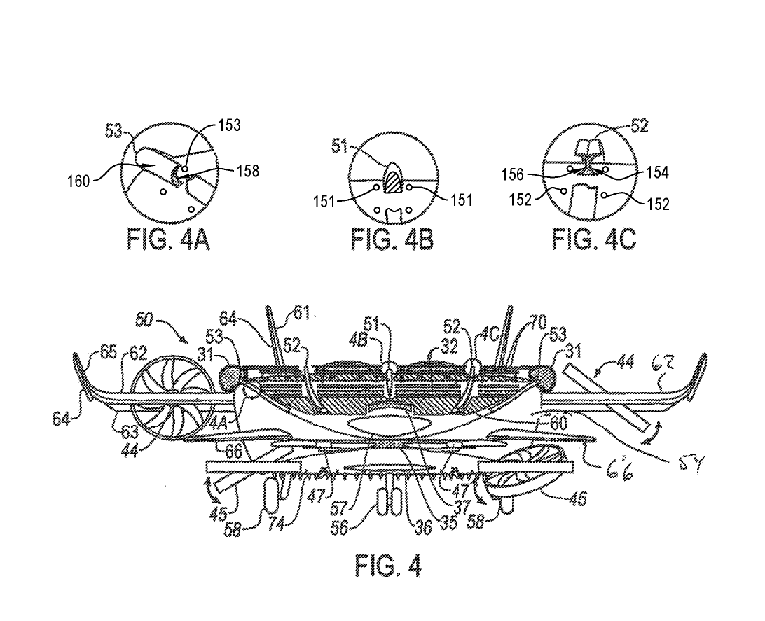

Turning now to FIG. 4 a front view of the aircraft 50 is shown illustrating the Forward Retractable Contractible Gimballed Ducted Fans 45, the Main left and right Landing Gear 58, the Nose Landing Gear 56, the stream airflow enhancement nozzles 74, the Retractable Pivotal Realign-able Counter rotating Stacked Propeller Pairs 47, the Front Central Fan Air Discharge 36, The Front Central Fan Air Intake and Propeller Retraction Stowage 35. Mounted on either side of the front of the Wing/Fuselage 54 are the Canard segments 66. At the forward top centre of the wing/fuselage is the Central Operational Control Area 57. Just above it is the front central fan upper air intake 37, also shown in this area as diagonal lines is the depiction of solar collector panels 60.

Extending from a position proximate to the front of the aircraft in a longitudinal direction along a center line the fuselage towards the back of the aircraft is the center fuselage airflow alignment strake 51 as further depicted in FIG. 4B. The center fuselage alignment strake 51 extends along both the top and/or the bottom of the aircraft 50, as illustrated in FIGS. 1 and 3. As best shown in FIG. 4B according to one embodiment, the center fuselage alignment strake 51 comprises a raised ridge extending outwards from the fuselage of the aircraft 50 with convex lateral outer surfaces although it will be appreciated that other cross-sectional profiles may be used as well. On the top of the aircraft 50, a plurality of center fuselage airflow ports 151 are spaced apart along either or both sides of the center fuselage airflow alignment strake 51. The center fuselage airflow ports 151 pass through the fuselage of the aircraft 50 in fluidic communication with the upper fuselage air intake plenum 33, depicted in FIGS. 9B and 9C.

To either side of the center fuselage airflow alignment strake 51 are the intermediate fuselage airflow alignment strakes 52, as depicted in FIG. 4C.

The intermediate fuselage airflow alignment strakes 52 extend along both the top and/or the bottom of the aircraft 50, as illustrated in FIGS. 1, 3 and 5. The intermediate fuselage airflow alignment strakes 52 comprise a profiled raised ridge extending outwards from the fuselage of the aircraft 50. According to one embodiment, a cross-section of the profiled raised ridge is illustrated in FIG. 4C, which includes concave lateral surfaces 154 and 156 on either side of each intermediate fuselage airflow alignment strake 52 although it will be appreciated that other cross sectional profiles may be used as well. On the top of the aircraft 50, a plurality of intermediate fuselage airflow ports 152 are spaced apart along either or both sides of the intermediate fuselage airflow alignment strakes 52. The intermediate fuselage airflow ports 152 pass through the fuselage of the aircraft 50 in fluidic communication with the upper fuselage air intake plenum 33, depicted in FIGS. 9B and 9C. The concave profile of each side of the intermediate fuselage airflow alignment strakes 52 serves to turn back air flow attempting to move towards the side of the aircraft thereby preserving linear lengthwise flow over the fuselage body.

On the outboard edges of the wing/fuselage are the outer fuselage airflow alignment strakes 53, as depicted in FIG. 4A. The outer fuselage airflow alignment strakes 53 extend along both the top and/or the bottom of the aircraft 50, as illustrated in FIGS. 1, 3 and 5. The outer fuselage airflow alignment strakes 53 comprise a profiled raised ridge extending outwards from the fuselage of the aircraft 50. The outer fuselage airflow alignment strakes 53 may have any shape as desired and in particular may have a cross-section of the profiled raised ridge as illustrated in FIG. 4A, which includes a center-facing concave lateral surface 158 and an outer-facing convex lateral surface 160 on each outer fuselage airflow alignment strake 53. On the top of the aircraft 50, a plurality of outer fuselage airflow ports 153 are spaced apart along the fuselage of the aircraft 50 proximate to the center-facing concave surface 158 and/or the outer-facing convex lateral surface 160 of the outer fuselage airflow alignment strakes 53. The outer fuselage airflow ports 153 pass through the fuselage of the aircraft 50 in fluidic communication with the upper fuselage air intake plenum 33, depicted in FIGS. 9B and 9C. The concave profile of the inner surface of the outer fuselage airflow alignment strakes 53 serves to turn back air flow attempting to move towards the side of the aircraft thereby preserving linear lengthwise flow over the fuselage body.

The purpose of the airflow ports 151, 152 and 153 is to remove air from the top surface of the fuselage adjacent to the airflow alignment strakes 51, 52 and 53 thereby improving boundary layer attachment and linear flow thereover so as to improve airflow efficiency and lift of the fuselage 54 as well as to reduce wing edge vortices. The airflow ports 151, 152 and 153 are distributed lengthwise along the aircraft 50 in any quantity and spacing as is determined to be necessary according to known principles to provide such boundary attachment.

Also shown in this area are the upper fuselage engine air intakes 32. Further back, the tomahawk retractable laminar flow enhancement devices 70, are shown in the extended or raised orientation. Even further back, the upper portions of the vertical stabilizers 61 and rudders 64 are visible. At the outside top edges of the wing/fuselage, the side engine air intake shrouds 31 are shown. At the right side of 54, one of the aft retractable contractible gimballed ducted fans 44 is shown in one of the many possible orientations and shroud retraction options; mounted on one of the reactive control wings 62. At the left side of 54, the other aft retractable gimballed contractible ducted fan 44 is shown in a different orientation, mounted on the other reactive control wing 62. In this same area, the combination roll control/elevator/trim tab 63, the winglet rudder 64, and the winglet 65 are depicted.

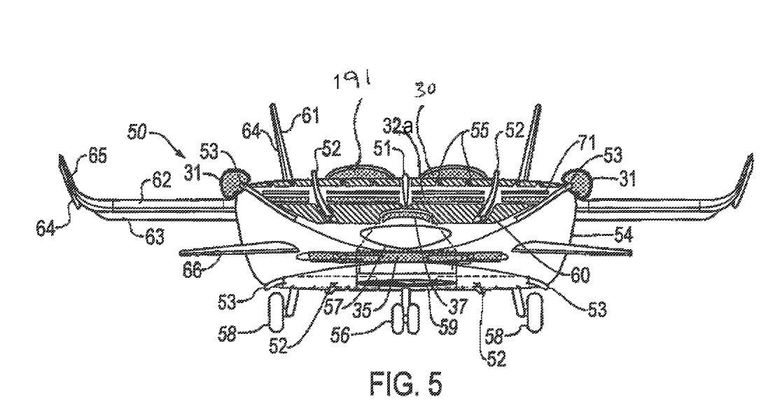

As illustrated in FIG. 5 many of the elements of FIG. 4 including the gimballed fans, as well as the forward counter rotating stacked propeller pairs, are retracted into the wing/fuselage 54 and the reactive control wings 62. Additionally, the intermediate 52, and outer 53 fuselage airflow alignment strakes are depicted on the lower surface of the fuselage, as outlined above. Also newly shown in this embodiment are some of the combined tomahawk retraction and airflow enhancement compressed air expression slots 71. Further, the upper fuselage contoured NACA engine air inlet vents 91 and the main engine air inlets 30 are shown on the upper centre part of the aircraft.

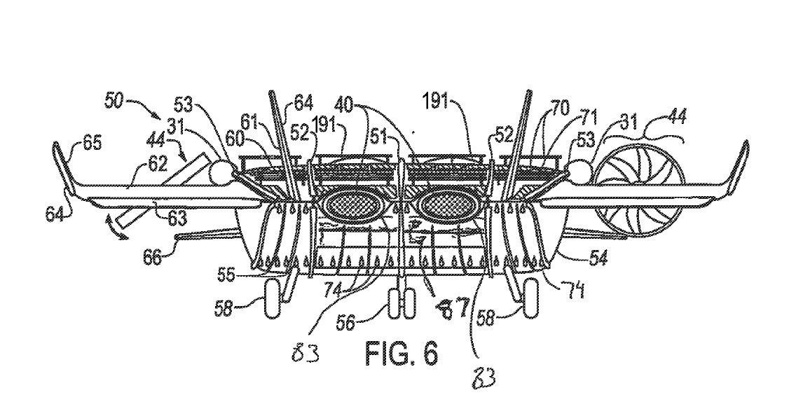

Turning now to FIG. 6 rear view of the aircraft 50 is illustrated wherein, at the bottom of the figure, the main landing gear 58 and nose landing gear 56 are seen. At the bottom of the wing/fuselage 54, the stream airflow enhancement nozzles 74, the Aft Hatch 87, and lower surface airflow orientation troughs 55, are shown. The trailing edge of the wing/fuselage include the engine thrust vectoring nozzles 40 and the thrust vectoring nozzles cooling airflow enhancement ducts 83. Also shown at the trailing edge are the dividing points of the centre 51, intermediate 52, and outer 53, upper and lower fuselage airflow alignment strakes. Additionally, the vertical stabilizers 61 and rudders 64 extend from the fuselage. On the left side of the figure, combination roll control/elevator/trim tabs 63, the winglet rudder 64, and winglet 65 are shown, mounted on the reactive control wing 62. The aft retractable gimballed contractible ducted fan 44 is depicted in one of the many possible orientations and shroud retraction options. On the right side of the figure, the other aft retractable gimballed contractible ducted fan 44 is mounted within the other reactive control wing, in a different orientation.

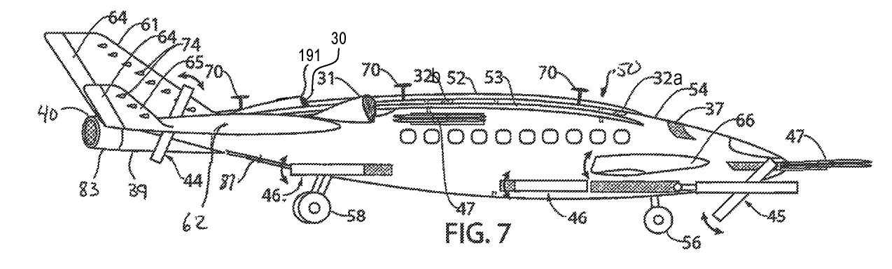

As illustrated from the right side of the aircraft in FIG. 7, at the front of the aircraft 50, the retractable pivotal realign-able counter rotating stacked propeller pairs 47 are shown in their extended position. Aft of the front propellers, the Canard segment 66 is shown above the stowage compartment for the right side forward retractable gimballed contractible ducted fan 45. Aft of the stowage compartment, the two rotatable retractable contractible side ducted fans 46. Aft of the rear side fan, the aft hatch 87 is shown in its' closed position. Near the front of the figure, the front central fan upper air intake 37 and the upper fuselage engine air intake 32, are shown; with another upper fuselage engine air intake 32 near the mid-chord area. A tomahawk retractable laminar flow enhancement device 70 is shown extended or raised, on the upper surface near the front, and is also seen at two further aft locations. The right side intermediate 52, and outer 53, fuselage airflow alignment strakes, are also shown along the upper surface. Each of the airflow alignment strakes is shaped to have a curved surface oriented toward the midline of the aircraft so as to redirect air moving to the side of the aircraft back to the middle portion thereby maintaining a greater amount of airflow along the length thereof. Near the middle of the wing/fuselage, one of the retractable pivotal realignable counter rotating stacked propeller pairs 47 is shown in an extended orientation. On the aft portion of the fuselage, the side Engine and APU air intake 31, and the main engine air inlets 30, along with the upper fuselage contoured NACA engine air inlet vents 91 are shown. Also shown in this area, is one of the aft retractable contractible gimballed ducted fans 44, in one of the many possible orientations and shroud extension options; which is shown mounted in one of the reactive control wings 62. A winglet 65 and a vertical stabilizer 61, with their attached rudders 64, and stream airflow enhancement nozzles 74, are shown above the engine and APU exhaust cooling jacket 39 and an engine thrust vectoring nozzle 40, also shown is the thrust vectoring nozzles cooling airflow enhancement ducts 83.

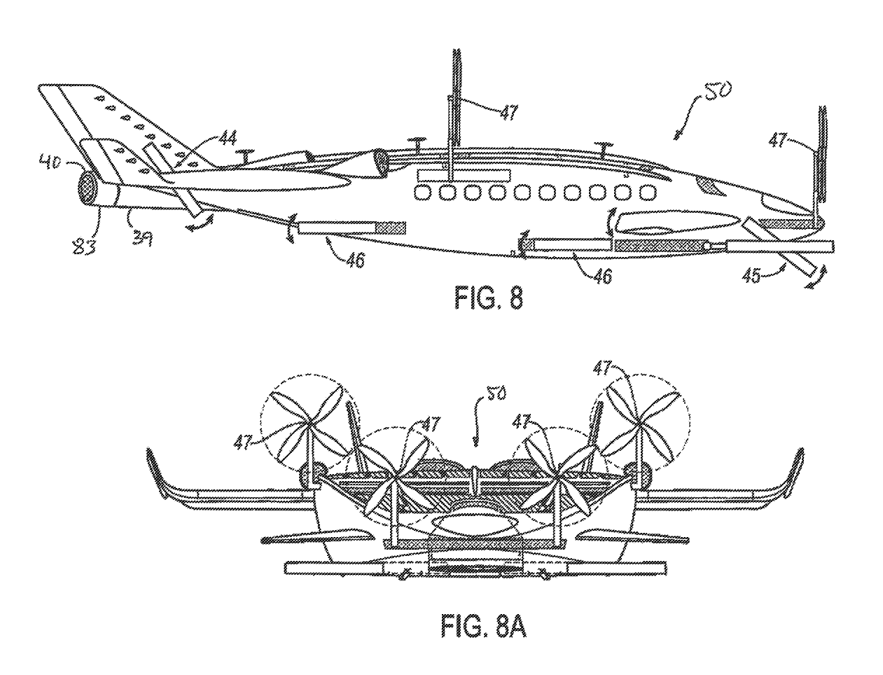

Turning now to FIGS. 8 and 8A, after the nose 56 and main 58 landing gear have been retracted, the retractable pivotal realign-able counter rotating stacked propeller pairs 47 may be realigned to the vertical position to create forward thrust, and improve laminar airflow over the upper wing surfaces.

Turning now to FIG. 9, a partial cutaway of the forward portion of the figure shows the front central fan air intake and propeller retraction stowage 35, the front central fan air discharge 36, the front central fan upper air intake 37, the front central fan main plenum 38, the front central fan 43, and the iris vane ducted fan cover 59. FIG. 9A shows partial cross section of the upper fuselage engine air intake 30, the upper fuselage engine air intake Plenum 33, the engine and APU air intake plenum 34, a portion of the high bypass turbine Jet engine 41, and the upper fuselage contoured NACA engine air inlet vent 91. As illustrated in FIGS. 9B and 9C the upper fuselage air intake plenum 33 is shown along with two upper fuselage air intakes 32 and two upper fuselage recessed NACA engine air inlet vents 90. FIG. 9D depicts a cross section of the upper fuselage airflow enhancement compressed-air expression slot 68 and a compressed air plenum 81.

At the rear of the aircraft, the rear hatch 87 is shown partially open with the UAV (Unmanned Aerial Vehicle) launch/retrieval system 92 deployed, comprised of the UAV launch retrieval device 93, the UAV data receiver and mission programming interface 94, the UAV orientation control transmitter/receiver 95, the UAV 96, and the UAV docking/alignment lock and data programming interface 97.

As illustrated in FIG. 9E, the compressed air plenum 81 includes a lower fuselage airflow enhancement compressed air expression slot 69. The slot 69 includes depression located proximate thereto as illustrated in FIG. 9E to draw air exiting the slot 69 closer to the fuselage thereby keeping the airflow along the fuselage and increasing the boundary layer attachment. As illustrated in FIG. 9F, a cross section of the tomahawk retractable laminar flow enhancement device 70, the combined tomahawk retraction and airflow enhancement compressed air expression slot 71, and a compressed air plenum 81 are shown. The slot 69 tomahawk retractable laminar flow enhancement device 70 draws air exiting the slot 71 closer to the fuselage thereby keeping the airflow along the fuselage and increasing the boundary layer attachment at lower speeds of the aircraft. At higher speeds, the tomahawk retractable laminar flow enhancement device 70 may be retracted to reduce drag. It will be appreciated that the tomahawk retractable laminar flow enhancement device 70 may be retracted into the slot 69 or into another recess in the fuselage.

To become airborne, there are several different configuration possibilities, using different attributes of the design. One of the possible methods of flight is the VTOL mode capability. In this mode, all of the Rotational Devices (comprising all vertically configurable fans including without limitation, the front center fan 43, the aft retractable contractible gimballed ducted fan 44, the forward retractable contractible gimballed ducted fan 45 and the retractable rotatable contractible ducted side fan 46) are deployed initially as Rotational Lifting Devices (RLD) in a horizontal orientation. This is done primarily to provide vertical lift, while also using some capability of the devices as attitude and directional control devices to maintain a stationary hover. In this mode, the front center fan 43, the Retractable Rotatable Contractible Side Ducted Fans (side fans 46), the Forward Retractable Contractible Gimballed Ducted Fan (forward fans) 45, and the Aft Retractable Contractible Gimballed ducted fans (aft fans) 44, are used primarily as vertical lifting devices, in a horizontal orientation; while also contributing in a limited way, as attitude control devices. The Retractable Pivotal Realign-able Counter rotating Stacked Propeller pairs 47, are deployed in a horizontal orientation and are used primarily as yaw adjustment devices but also have some control over attitude, height, and position; while contributing significantly to the lift component. The vectored thrust nozzles 40 can be manipulated and directed individually, thereby also somewhat contributing to lift, attitude control, and yaw, in a restricted capacity during takeoff and hover.

Another possible method of becoming airborne, the STOL Mode capability, is accomplished by using the rotational devices in a combination of lift, attitude, yaw, and thrust control configurations. In this situation, the reactive wings, the canards, and the wing/fuselage, using various airflow enhancement and lift augmentation devices, also contribute to lift. While the primary thrust motive force in this mode are the high bypass turbine engines, the propellers 47, mounted on the sides and front of the wing/fuselage 54, devote most of their capability to forward thrust as well; as depicted in FIGS. 8 & 8A. The aft fans 44, side fans 46, forward fans 45, and centre fan 43, are used primarily in this mode, as RLD's. The orientation of all of the rotational devices is variably dependent upon the takeoff area available, including adjustments for obstacles after liftoff. When obstacle clearance is assured, the fans begin to be re-oriented to provide more forward thrust. The effect of the orientation of these rotational devices, is additional forward thrust and additional lift created by the laminar flow enhancement effect of the air blown by the propellers over the upper surface of the wing. During this transition from focusing on becoming airborne to changing the focus to forward flight, which results in the reactive control wings and wing/fuselage creating more lift, the fans are also beginning to be reoriented to a more vertical position. In doing so, an increasing amount of the power of these fans is directed as forward thrust, until their lifting and attitude control power is no longer required; when all of their power is used for forward thrust. When airspeed reaches the velocity when drag reduces the effectiveness of the RLD's, they are retracted, and all of the forward motive force is provided by the engines

During takeoff in other than VSTOL Mode, the aircraft is allowed to roll forward on the undercarriage. In so doing, airflow is created around both the reactive wings 62 and wing/fuselage 54 as well as the Canards 66; which all have airflow enhancement and lift augmentation devices. One of the more significant of the airflow enhancement/lift augmentation systems is the provision of engine air intake ducts 30 and 32 as depicted in FIGS. 9A, B & C at three different locations along the upper surface of the wing/fuselage. By drawing the air from the upper surface of the wing/fuselage, the laminar flow of air is held closer to the surface by the entrainment and inducement effects, which in turn increases the boundary layer adhesion.

Other airflow enhancement devices included on the upper surface of the wing/fuselage, are the tomahawk style, retractable laminar flow enhancement devices 70 which result in both entrainment and inducement of airflow, and can be retracted into the compressed air expression slots 71 as depicted in FIG. 9F, which also are airflow enhancement devices in their own right. There is an airflow enhancement compressed air expression slot 68, without a tomahawk device, near the outer sides of the upper surface mid-point of the chord, as well as on the aft portion between the vertical stabilizes 61; as further depicted in FIG. 9D. This slot has been strategically located on the upper surface curvature to increase airflow and entrain surrounding air to improve boundary layer adhesion at two of the most typical points of boundary layer separation on a wing.

Additionally, combination sheet/stream airflow enhancement nozzles 72 are situated on the leading edges of the canards and reactive wings to force air over the top of the canard as sheets and as streams along the bottom thereof. As well, sheet airflow enhancement nozzles 73 are located on the trailing edges of the canards and reactive wings which are adapted to output air from the trailing edge of the canard to reduce drag by improving integration of the top and bottom airflows.

Because the chord of the wing/fuselage is so long, this embodiment provides airflow alignment strakes 51, 52 and 53, respectively on both the upper and lower surface of the wing/fuselage 54; as depicted throughout, and particularly in FIGS. 4A, 4B and 4C. These strakes maintain a directional airflow over the airfoil surfaces, to ensure that lift power is not lost by air developing a span-wise flow. That would result in diminished lift caused by airflow escapement off the sides of the wing/fuselage, creating drag inducing vortexes. Of further assistance in the quest for linear airflow along the extended cord, the upper and lower surfaces of the wing body have shallow troughs 55 as illustrated in FIG. 1B. As illustrated, the troughs 55 may extend substantially longitudinally along the fuselage 54 however other orientations may be selected as well to align with the airflow direction at that location. This figure shows the troughs in the open position with the dashed line indicating the profile that would result from the troughs being closed. By inflating or deflating the bladders 155 in the troughs, they can be altered in depth and profile from deep, to level with the surface of the wing/fuselage, or protruding; as best suited for the condition of flight. In addition to linear airflow improvement, the troughs also improve boundary layer attachment by providing programmed linear shear.

The undersurface of the wing/fuselage, reactive wings, and canards, also have airflow enhancement devices, as shown in FIG. 3, and the other figures that show partial lower surface views. Among those elements, are three rows of stream shaped compressed air nozzles 74 spaced to improve both directional flow and underwing pressure, and to enhance laminar airflow. As shown near the midpoint of the chord of the wing/fuselage lower surface, there is a compressed air expression slot 69, which is further detailed in FIG. 9E, to improve continued laminar airflow over the rear portion of the long chord of the wing. This Device helps to counter the disturbance of air flow over the lower surface caused by turbulence created from the fans and propellers. In addition, the lower surfaces of the canards, reactive wings, and rear fuselage have sheet shaped compressed air nozzles to improve the re-integration of the airflows on the upper and lower surfaces resulting in an improved Kutta effect, and reduced turbulence at the trailing edge; which reduces drag and improves efficiency enabling the transitional nature of this aircraft. The lower portion of fans 43 and 44, when not in use, are covered by iris vane mechanisms 59 to create a smooth airflow, which allows the lift to be maintained. The combination of these many features enable an exceptionally long cord wing to maintain efficient lift and control.

In this embodiment, many of the rotational devices, airflow enhancement devices, and system controls are powered by compressed air provided from the compressor section of the High Bypass Turbine Jet Engines 41 and the APU 42. This is particularly beneficial in that while the aircraft is being transitioned vertically, or maintained in Hover mode, no forward thrust is required. The compressed air therefore, can be used primarily to supply power for the various devices until forward flight is established, at which time, the engine power can be converted to forward flight motive force and the devices can be deactivated. However, the power supply could also be electrical, electromechanical, hydraulic, mechanical; or any combination thereof.

One of the more significant aspects of the design is the ability to take off and land vertically (VTOL), or from a short airfield or space (STOL), using the various ducted fans and propellers (rotational devices), to be rotational lifting devices (RLD). Some of these rotational devices are also used to initiate and control hover, then transition between stationary and forward flight. They can also be used to sustain forward flight. When not required for the particular mode of flight, the rotational devices can be retracted or covered to reduce the drag that would normally be associated with those devices. A further unique feature of the rotational devices is that in the event of engine failure, the air passing through the freewheeling fans or propellers would greatly reduce the descent rate of the aircraft and provide additional opportunity to find a safe landing location.

An additional possible takeoff or landing arrangement, is an augmented normal mode. In this mode, some or all of the propellers 47 are optionally deployed, realigned, or retracted as required for the takeoff or landing field length; to improve laminar flow, and assist the main engines 41 with initial thrust. Also optional are deployment and operation of the lift enhancement devices such as 68, 69, 70, 71, 73, & 74; dependent on the balanced field length and obstacles further along the flightpath. Once full lift capability and control is sufficiently provided by the wing/fuselage and reactive wings, assisted by the canards, the various rotational devices and lift or airflow enhancement devices can be slowed or stopped and ultimately stowed or retracted, to provide an aerodynamically clean wing capable of very high speed. Similar options are available to the operator of the aircraft when returning to land and the various elements can be reinstated in the landing flight profile as required. Each flight segment can be accomplished with the various embodiments tailored to the operational requirements of the particular mission.

With the many rotational lifting devices and airflow enhancement devices, this aircraft has unique capabilities. The design of this aircraft, with its' low speed extreme maneuverability and hover capability, combined with high speed capability, makes it well suited for Surveillance, Loiter, Reconnaissance, SAR, as well as Sensor and Armament platforms. With its large interior volume and large rear access hatch, it is also ideal for Troop, Personnel, and Freight transport, or airborne payload drop. The ability to safely accomplish unplanned or planned enroute stops on unprepared surfaces or very small airfields, makes this aircraft a very valuable logistic asset. The wide fuselage with rear loading wide hatch is ideal for loading/unloading large freight items or mass troop or medical evacuation.

This aircraft is uniquely qualified to act as a manned or unmanned transport and support vehicle for A swarm of UAV's, as it is capable of launching, monitoring and retrieving a variety of medium sized drones that are themselves capable of launching, monitoring, and retrieving smaller drones. The UAV launch/retrieval system 92 provides the capability of recharging, refueling, reprogramming, or uploading/downloading and forwarding data, in support of the dependent drones.

The Thrust Vectoring Nozzle Cooling and Airflow Enhancement Duct 83, which employs an extending profile provides increased airflow which creates increased trust. It also provides cooling to the exhaust airstream, which together with the design of the air distribution system and the air cooling jacket exchanger 39 around the engines and APU, results in a low heat signature; thereby contributing to the aircrafts' stealth capability.

As illustrated in the attached Figures, the references characters are identified as follows:
30 Main engine air intake
31 Side engine and APU air intake shroud
32 Upper fuselage engine air intake
33 Upper fuselage engine main air intake plenum
34 Engine and APU air intake Plenum
35 Front center fan air forward intake, and propeller retraction stowage
36 Front center fan air discharge
37 Front center fan upper air intake
38 Front center fan main plenum
39 Engine and APU exhaust cooling jacket
40 Engine thrust vectoring nozzle
41 High bypass turbine jet engine
42 APU
43 Front center fan
44 Aft retractable contractible gimballed ducted fan
45 Forward retractable contractible gimballed ducted fan
46 Retractable rotatable contractible ducted side fan
47 Retractable pivotal realign-able counter rotating stacked propeller pair
48 Ducted fan Central body shroud
50 Aircraft
51 Center fuselage airflow alignment strake
52 Intermediate fuselage airflow alignment strake
53 Outer fuselage airflow alignment strake
54 Wing/fuselage
55 Wing/fuselage surface airflow orientation troughs
56 Nose landing gear
57 Central operational control area
58 Main landing gear
59 Iris vane ducted fan covers
60 Solar power collector panels
61 Vertical stabilizers
62 Reactive control wings
63 Combination roll control/elevator/trim tabs
64 Wing-let and vertical stabilizer, rudders
65 Wing-let
66 Adjustable canard
68 Upper fuselage airflow enhancement compressed air expression slot
69 Lower fuselage airflow enhancement compressed air expression slot
70 Tomahawk retractable laminar flow enhancement device
71 Combined tomahawk retraction and airflow enhancement compressed air expression slot
73 Sheet airflow enhancement nozzle
74 Stream airflow enhancement nozzle
78 Modulating valve
79 Control valve
80 Pressure relief vane
81 Air expression slot plenum
83 Thrust Vectoring Nozzle Cooling and Airflow Enhancement Duct
84 Airflow Adhesion Enhancement Profile
87 Aft hatch
90 Upper fuselage recessed NACA engine air inlet vent
91 Upper fuselage contoured NACA engine air inlet vent
92 UAV launch/retrieval system
93 UAV launch/retrieval device
94 UAV data receiver and mission programming interface
95 UAV orientation control transmitter/receiver
96 UAV (unmanned aerial vehicle)
97 UAV Docking/alignment lock and data programming interface
115 Compressed air supply
151 center fuselage airflow ports
152 intermediate fuselage airflow ports
153 outer fuselage airflow ports
154 concave lateral surface
155 bladders
156 concave lateral surface
158 center-facing concave lateral surface
160 outer-facing convex lateral surface
171 upper compressed air expression slot
172 lower compressed air expression slot
191 scoop

While specific embodiments of the invention have been described and illustrated, such embodiments should be considered illustrative of the invention only and not as limiting the invention as construed in accordance with the above accompanying claims.

What is claimed is:

1. A cruise efficient conventional vertical short take off and landing aircraft comprising:
a fuselage having an outer surface profile selected to conform to an airfoil profile;
at least one engine located within said fuselage;
a plurality of air intakes distributed over a top surface of said outer surface;
at least one duct extending through said fuselage;
wherein said at least one duct is in fluidic communication with said plurality of air intakes and said at least one engine.

2. The aircraft of claim 1 further comprising a plurality of raised ridges extending upwards from said fuselage along said top surface thereof between a location proximate to a front of said fuselage and a rear of said fuselage.

3. The aircraft of claim 2 further comprising a plurality of airflow removal ports extending through said fuselage proximate to said plurality of raised ridges in fluidic communication with said at least one duct.

4. The aircraft of claim 2 wherein each of said plurality of raised ridges comprise a group consisting of a center ridge extending along a centerline of said fuselage, an outer ridge extending proximate to a side edge of said fuselage and an intermediate ridge located between said center ridge and said outer ridge.

5. The aircraft of claim 4 wherein said center ridge includes convex lateral surfaces.

6. The aircraft of claim 4 where said intermediate ridge includes concave inward and outward facing lateral surfaces.

7. The aircraft of claim 4 wherein said outer ridge includes a concave inward facing lateral surface.

8. The aircraft of claim 1 wherein said plurality of air intakes are distributed lengthwise over said top surface of said fuselage.

9. The aircraft of claim 8 wherein said plurality of air intakes are distributed along said top surface at each of three locations along a length of said fuselage.

10. The aircraft of claim 9 wherein said plurality of air intakes have a profiled NACA duct configuration.

11. The aircraft of claim 10 wherein a rearmost of said plurality of air intakes include scoops extending thereabove from said top surface of said fuselage.

12. The aircraft of claim 11 wherein said scoops include pressure relief panels extending therethrough operable to open upon over pressurization of air under said scoops.

13. The aircraft of claim 1 further comprising a plurality of air outlet nozzles along a bottom surface of said fuselage to express air therefrom.

14. The aircraft of claim 13 wherein said plurality of air outlet nozzles are distributed transversely across said bottom surface of said fuselage.

15. The aircraft of claim 14 wherein said plurality of air outlet nozzles are distributed along said bottom surface at each of three locations along a length of said fuselage.

16. The aircraft of claim 14 wherein said plurality of air outlet nozzles are oriented in a direction towards said rear of said fuselage so as to express air therefrom along said fuselage.

17. The aircraft of claim 14 wherein each of said plurality of air outlet nozzles includes a valve therein.

18. The aircraft of claim 14 wherein each of said plurality of air outlet nozzles includes a dimple in said fuselage located downstream therefrom.

19. The aircraft of claim 1 further comprising at least one air expression slot extending transversely across said fuselage adapted to express air therefrom located along at least one of said bottom or top of said fuselage.

20. The aircraft of claim 19 wherein said at least one air expression slots are oriented in a direction towards said rear of said fuselage so as to express air therefrom along said fuselage.

21. The aircraft of claim 19 wherein said at least one air expression slots includes a depression located rearwardly of said at least one of said air expression slots.

22. The aircraft of claim 19 wherein said at least one air expression slots includes an airfoil adapted to be moved between a retracted position within said fuselage and an extended position substantially parallel to and apart from said fuselage at a position proximate to and rearward of said air expression slot.

23. The aircraft of claim 22 wherein said airfoil includes air expression outlets on top and bottom surfaces thereof adapted to express air therefrom in a direction generally towards a rear of said fuselage.

24. The aircraft of claim 1 further comprising a plurality of longitudinal troughs located into said fuselage along at least one of said top or bottom of said fuselage.

25. The aircraft of claim 24 wherein said troughs include an air bladder therein so as to be operable to fill the trough to conform to the adjacent profile of the fuselage.

26. The aircraft of claim 1 further comprising a plurality of fan selectably retractable into said fuselage.

27. The aircraft of claim 26 wherein at least one of said plurality of fans comprises a ducted fan.

28. The aircraft of claim 26 wherein at least one of said plurality of fans is rotatable about an axis which is orientable in a direction to be varied between vertical to provide vertical lift to said aircraft and horizontal to provide thrust to said aircraft and combinations thereof.

29. The aircraft of claim 27 wherein said at least one of said plurality of fans is positioned to blow air across said top surface of said fuselage.

30. The aircraft of claim 26 wherein said aircraft includes at least one duct extending vertically through said fuselage.

31. The aircraft of claim 30 wherein said at least one duct includes a fan therein.

32. The aircraft of claim 31 wherein said at least one duct is selectably openable and closable to isolate the fan within the duct.

33. The aircraft of claim 26 wherein said aircraft includes at least one duct extending through a wing extending therefrom.

34. The aircraft of claim 33 wherein said at least one duct includes a fan therein.

35. The aircraft of claim 34 wherein said at least one duct is selectably openable and closable to isolate the fan within the duct.
